(19) United States
(12) Patent Application Publication
(10) Pub. No.: US 2015/0235199 A1
(43) Pub. Date: Aug. 20, 2015

(54) SYSTEMS AND METHODS FOR FACILITATING FRICTIONLESS TRANSACTIONS IN A CLIENT/SERVER ENVIRONMENT

(71) Applicant: BUYREPLY HOLDINGS PTY LTD., Vaucluse (AU)

(72) Inventor: Brad Marc Lindenberg, Sydney (AU)

(21) Appl. No.: 14/626,845

(22) Filed: Feb. 19, 2015

Related U.S. Application Data
(63) Continuation of application No. 13/444,076, filed on Apr. 11, 2012, now abandoned.

(51) Int. Cl. G06Q 20/32; G06Q 30/02; G06Q 30/06; H04W 4/14; G06Q 50/00

(52) U.S. Cl. CPC G06Q 20/322; H04W 4/14; G06Q 50/01; G06Q 30/0613; G06Q 30/0633; G06Q 30/0203; G06Q 30/0212

(57) ABSTRACT

The field of the invention relates to systems and methods for network-based commerce, and more particularly to systems and methods for facilitating frictionless transactions between a user device and server system. In one embodiment, a server system is configured to execute a process including the steps of: receiving a text-based communication sent from the client device using a first native communication medium, the text-based communication having a source address, a recipient address, and one or more short-codes; parsing the text-based communication for said one or more short-codes; and replying to the source address using a second native communication medium with a purchase order for one or more products available from said recipient address defined in the server system, wherein said short-codes uniquely identify said one or more products; and confirming the order through the second native communication medium.

### CROSS-REFERENCE TO RELATED APPLICATIONS

The present application is a continuation of U.S. patent application Ser. No. 13/444,076, filed Apr. 11, 2012, the disclosure of which is incorporated herein by reference.

### FIELD OF THE INVENTION

The field of the invention relates to systems and methods for network-based commerce, and more particularly to systems and methods for facilitating frictionless transactions, such as by processing short-codes sent from a client device to a server using native mobile communication mediums.

### BACKGROUND OF THE INVENTION

An increasing number of business and consumer transactions are conducted electronically. With the growth of the Internet and network-based systems, electronic commerce (“e-Commerce”) offers users convenience and efficiency over traditional methods of developing, marketing, selling, and exchanging goods and services.

In a typical e-Commerce environment, many server computer systems (e.g., Web servers or Web sites) are configured to advertise and sell products over the Internet. A server computer system provides an electronic catalog of available products—uniquely identifiable via a Uniform Resource Locator (“URL”), for example. A remote client device submits a request (e.g., HyperText Transfer Protocol (“HTTP”)) specifying the catalog's URL in order to view the Web page for potential purchases. The Web page is often displayed in a browser on the remote client device where the user can view products (e.g., books, clothing, music) and select items for purchase. Once items are selected for purchase, the server computer system requests information from the remote client regarding purchase information (e.g., name, credit card, delivery data) to complete the transaction.

Selecting items for purchase can be achieved with a variety of different shopping models known in the art. Common methods are based on either: (1) a “shopping cart” model or (2) “one-click” technology. For current systems using the “shopping cart” model, items are selected for purchase and electronically added to a virtual “shopping cart.” Once a purchaser completes their selection, the items of the “shopping cart” can be “checked out” and the purchaser is presented with an order Web page. The purchaser enters their purchase information (e.g., name, credit card, delivery data), as discussed above, for submission to the server computer system. The server computer system validates the purchase information to complete the transaction. In some models, entering purchase information requires the purchaser to login to an account or create an account with the server computer system. Accordingly, this ordering process (i.e., selecting items, viewing items, entering purchase information, updating data) can be burdensome when ordering single or multiple items.

In “one-click” transaction systems, a purchaser is mapped to a server-assigned client identifier that allows the purchaser to complete an order in a single-action. An example is disclosed in U.S. Pat. No. 5,960,411, to Hartman et al., filed Sep. 12, 1997, for a “Method and System for Placing a Purchase Order via a Communications Network,” which is hereby incorporated by reference in its entirety (see also U.S. patent application Ser. No. 12/613,562, U.S. Publication No. 2010/0332337 A1, to Bullock, filed Jun. 25, 2009, for a “Universal One-Click Online Payment Method and System,” which is hereby incorporated by reference in its entirety). The server computer system may store purchase information for the client to minimize the transmission of sensitive information (e.g., encrypted names, credit card information, addresses). In response to a purchaser's single-action (e.g., clicking a mouse button), the server computer system combines the additional purchase information stored in association with the client identifier to effect the ordering of an item. Thus, instead of requiring multiple purchaser interactions, the one-click ordering process reduces the interactions between the client and server systems. Nevertheless, these current systems still require the user to log in or create a username/password to an account in order to conduct transactions using their server-assigned client identifier.

As an additional drawback, although single-action ordering systems facilitate the transmission of sensitive information over other models, both client and server systems continue to limit the efficiency of e-Commerce. For both “shopping cart” and “one-click” models, access to most e-Commerce server computer systems (e.g., electronic catalogs) is configured for stationary devices running Web browser software. These Web browsers are special-purpose application programs for accessing, viewing, and traversing information resources on the Web, as is well understood and appreciated. For example, a personal computer (PC) or stationary workstation's Web browser is typically used to communicate transaction/purchase information with the server computer system's Web application. The Web browser communicates information—product details, name, credit cards, server-assigned client identifiers, for example—with the server computer system to generate/complete an order. In some systems, the purchaser need only perform a single action (i.e., “one-click” systems). Unfortunately, many of these Web applications fail to accommodate non-stationary devices running Web browser software.

Advances in wireless technology allow purchasers to portably access the Web-based content discussed above; however, certain Web-content may still not be suitable for mobile device users. Mobile devices and portable computers (e.g., wireless and cellular phones, smartphones, pagers, personal digital assistants (PDA's), laptops, and so on) are convenient systems for accessing information over the Internet from virtually anywhere. With these advances in portability, a greater number of purchasing/buying decisions are being made away from stationary devices/home. Although an increasing number of consumers/purchasers are using mobile devices with wireless access to Web-based content, not all mobile devices have the hardware (e.g., memory capacity, processor, and so on) or software to host a browser with the same functionality as stationary devices.

In order to meet the demands of mobile consumers, some Web-content is specifically tailored to accommodate non-stationary devices. For example, conventional “Web-clipping” parses and extracts certain text and graphic information from a Web page in order to effectively display the information on a portable device. “Web-clipping” is often based on a predefined template to place the extracted data. Images, icons, text, and other graphics that do not fit into this template are not transmitted/displayed on the portable device. However, in an e-Commerce environment, certain images, icons, text, and other graphics are critical to the ordering process.

For both “shopping cart” and “one-click” models, images of products, checkout buttons, descriptive text, and so on are necessary for consumers to make informed purchasing decisions. Unfortunately, some of this necessary text and graphic data is lost to “Web-clipping” and other mobile tailoring methods. Without additional software (e.g., e-Commerce applications), purchasers on mobile devices are not able to effectively browse Web-based catalogs and select items for detailed views or purchases. Even where “one-click” e-Commerce systems attempt to facilitate the online ordering process, “Web-clipping,” and other mobile tailoring methods, can obstruct the single-action icon (e.g., a “buy now” or “checkout now” button) and make purchases through Web browsers—particularly mobile browsers—more cumbersome than traditional purchasing methods. Furthermore, restricting e-Commerce to certain Web-browsers limits consumer transactions not only through mobile devices, but also over alternative broadcast mediums (e.g., television, radio, print catalogues, e-mail, and so on). Accordingly, an improved system and method for facilitating secure, frictionless transactions without the need for a Web browser in a network environment is desirable.

### SUMMARY OF THE INVENTION

The field of the invention relates to systems and methods for network-based commerce, and more particularly to systems and methods for facilitating frictionless transactions in a client/server environment. In one embodiment, a client device is configured to access a data network and a Global System for Mobile Communications (“GSM”) network. The system further includes a server system that defines an inventory of products for distribution to a user of the client device. The server system is accessible over the data network and also includes a computer program product having a computer-usable medium with a sequence of instructions which, when executed by a processor, causes said processor to execute a process that facilitates frictionless transactions between the client device and server system.

The process includes the steps of receiving a text-based communication sent from the client device using a first native communication medium, the text-based communication having a source address, a recipient address, and one or more short-codes; parsing the text-based communication for said one or more short-codes; and replying to the source address using a second native communication medium. In one embodiment, replying to the source address comprises generating a purchase order for one or more products available from said recipient address defined in the server system, wherein said short-codes uniquely identify said one or more products; confirming the order through the second native communication medium; and processing a payment for said order upon receipt of confirmation from said client device.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 is a block diagram of an exemplary network environment including a Global System for Mobile Communications (GSM) network in accordance with a preferred embodiment of the present invention.

FIG. 2 is a flowchart of a process in accordance with a preferred embodiment of the present invention.

FIG. 3a is a flowchart further illustrating the process of matching active campaigns performed in the process described in FIG. 2;

FIG. 3b is a flowchart further illustrating a step performed in the process described in FIG. 2.

FIG. 4 is a flowchart further illustrating a step performed in the process described in FIG. 2.

FIG. 5a is a flowchart further illustrating a consumer transaction based on a user communication described in FIG. 2;

FIG. 5b is a flowchart further illustrating a product lookup performed in the process described in FIG. 2.

FIG. 6 is a flowchart further illustrating a purchase confirmation performed in the process described in FIG. 2.

FIG. 7 is another flowchart of a process in accordance with a preferred embodiment of the present invention; and

FIG. 8 is another flowchart of a process in accordance with a preferred embodiment of the present invention.

### DETAILED DESCRIPTION OF THE PREFERRED EMBODIMENTS

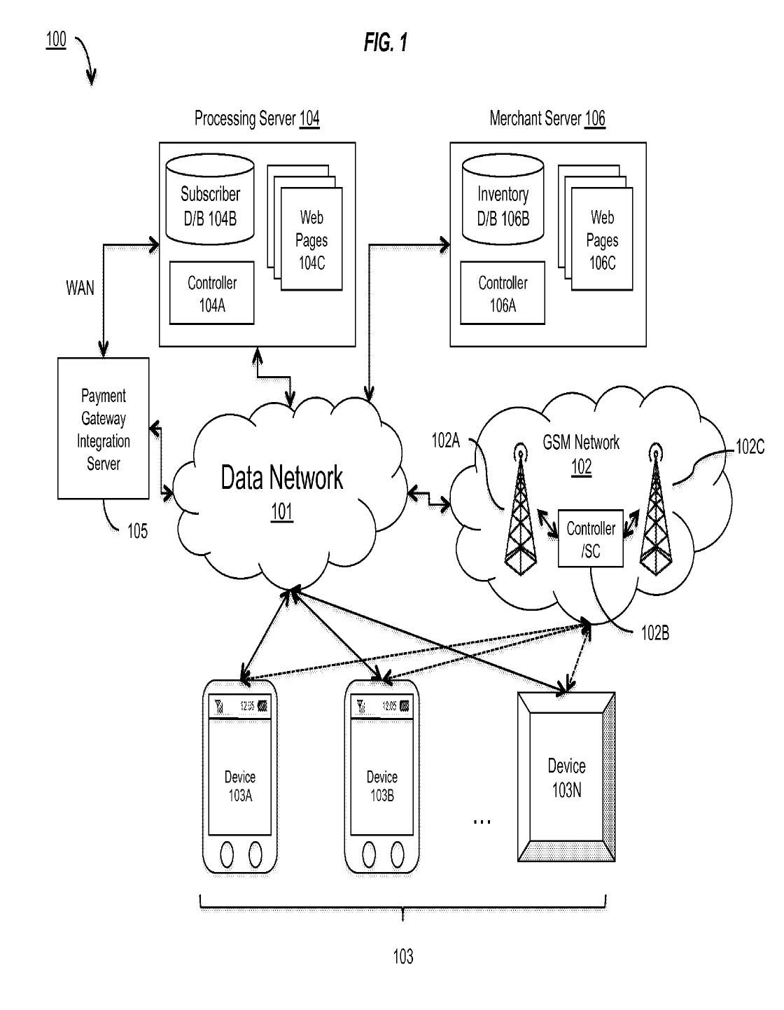

As described above, e-Commerce empowers users to conduct business or commercial transactions over electronic systems, such as the Internet or other data network. Turning to FIG. 1, an exemplary system 100 for facilitating frictionless consumer transactions is further illustrated in block diagram form. The system 100 includes a processing server 104 having a controller 104A, a subscriber database 104B, and several web pages 104C. Subscriber database 104B contains information for both users (e.g., users 103) and merchant subscribers. For example, names, billing information, and shipping information is stored in subscriber database 104B. Merchant subscribers are associated with a unique campaign address (e.g., address@domain_name or @twitterhandle) to identify a particular merchant. As one of ordinary skill in the art would appreciate, subscriber database 104B may be any type of storage device or storage medium such as hard disks, cloud storage, CD-ROMs, flash memory, DRAM and may also include a collection of devices (e.g., Redundant Array of Independent Disks (“RAID”)). Subscriber database 104B may reside on the same computing device or on a different computing device than processing server 104. Server controller 104A handles requests to view items of database 104B, often as Web pages 104C. Standard networking protocol (e.g., HyperText Transfer Protocol (“HTTP”), HTTP Secure (“HTTPS”), Transport Layer Security (“TLS”), and Secure Sockets Layer (“SSL”)) requests may be used to access the Uniform Resource Locator (“URL”) of web pages 104C.

System 100 further includes a merchant server 106 having a server controller 106A, an inventory database 106B, and several web pages 106C. Inventory database 106B contains, inter alia, product details for the goods or services that can be ordered from merchant server 106. As described above, inventory database 106B may be any type of storage device or storage medium and may reside on the same computing device or on a different computing device than merchant server 104. Similarly, merchant server 106 and processing server 104 may comprise a single computing device or multiple computing devices. Server controller 106A handles requests (e.g., standard networking protocols) to view items of database 106B, often as web pages 106C, for details on product inventory.

Items for sale are defined in inventory database 106B and classified as one of three types: (1) shippable goods; (2) virtual goods; or (3) informational. Shippable goods are physical items exchanged for a payment that will be shipped to a user/consumer (e.g., books, clothing, and so on). Similarly, virtual goods are items exchanged for a payment but do not require freight (e.g., electronic audio file). Informational items typically do not require a payment method and provide information to the user/consumer (e.g., application forms, maps, excerpts from books). Items for sale can also be marked active or inactive to indicate whether an item in database 106B is available or no longer available, respectively. In this specification, “products” and “items” are used as generic terms for any of the goods or services available from a merchant, regardless of whether a price is required.

Each item is uniquely identifiable via a short-code or similar stock-keeping unit (“SKU”), such as, for example a numerical identifier. In a preferred embodiment, processing server 104 assigns unique 4-digit short-codes to each product. Merchants alternatively can create unique custom short-codes to override server-assigned codes (e.g., plain text words such as “BUY” or “LAPTOP”). Although a single product may have a unique SKU, the product may have one or more unique short-codes. Each short-code may represent a different embodiment of the same item. For example, an item for sale in a television ad is offered for $99 using short-code A111. The same item, having the same SKU, may be offered for $70 in a print catalogue using short-code A123. In another example, merchants may sell tickets for a discounted price during a “pre-sale” using a first short-code until a limited quantity is sold-out. The merchants may subsequently sell the remaining tickets, having the same SKU, for a different price using a second short-code. Therefore, multiple short-codes for a single item provide the advantage of identifying not only a particular product, but also metrics related to that item (e.g., various pricing, advertising mediums, sale quotas, and so on).

Furthermore, inventory can be managed via parent/child short-code relationships. Child short-codes are used when a particular product is available in multiple configurations (e.g., clothing in multiple sizes and colors). Child codes inherit the activation properties of their parent codes (e.g., an inactive parent short-code implies an inactive child short-code). However, product inventory (e.g., quantity), short-codes, custom short-codes, pricing, and so on for items with a parent/child short-code relationship are managed at the child level.

System 100 further includes a payment gateway integration server 105 that can be configured to process payments on behalf of a merchants desired payment processor to facilitate the authorization of electronic payment information. Payment gateways are application service providers for securely transferring transaction details between a payment portal and acquiring source. One skilled in the art would appreciate that system 100 may include multiple payment gateway integration servers 105 configured for various payment transactions.

Users 103 make electronic purchases on their client devices 103A, 103B, and 103N. Client devices 103A, 103B, and 103N are preferably portable communication devices supporting wireless communications, such as mobile telephones, smart phones, text messaging devices, handheld computers, pagers, beepers, and so on. However, devices 103A, 103B, and 103N also include, laptop computers, personal digital assistants (PDA), portable multimedia players, desktops, multiprocessor systems, microprocessor-based systems, programmable consumer electronics, telephony systems, distributed computing environments, set top boxes, and so on.

In one embodiment, client devices 103A, 103B, and 103N communicate with each other and other wireless devices over Global System for Mobile Communications (GSM) network 102. The GSM network 102 includes, inter alia, base transceiver stations 102A, 102C and a controller 102B. Controller 102B manages a mobile switching center and messaging service center for various communication among devices 103A, 103B, and 103N. In one embodiment, GSM network 102 comprises a circuit switched network. For example, users 103 can send and receive text messages (e.g., Short Message Service (“SMS”), Multimedia Messaging Service (“MMS”), Enhanced Messaging Service (“EMS”), proprietary messages—Apple's iMessage® and BlackBerry's Messaging® service, for example—and so on) and make wireless calls over GSM network 102. The devices 103A, 103B, and 103N communicate wirelessly, represented as dashed lines in FIG. 1, with base transceiver stations 102A, 102C to relay signals to controller 102B. Controller 102B is configured to transmit calls and messages over GSM network 102 (e.g., through a mobile switching center connected to a public switched telephone network (PSTN) or SMS gateways) to the appropriate destination device.

GSM networks are generally well known and appreciated to those of ordinary skill in the art and are further described in Mouly, M, and Pautet, M-B, “The GSM System for Mobile Communications,” ISBN 2-9507190-0-7. Similarly, it should be understood that although a GSM network is described in one embodiment of the present invention, network 102 may comprise similar communications standards including, but not limited to, Code Division Multiple Access (CDMA), Time Division Multiple Access (TDMA), General Packet Radio Service (GPRS), Frequency Division Multiple Access (FDMA), Orthogonal Frequency Divisional Multiplexing (OFDM), and so on.

System 100 further includes a data network 101 for data transmissions, such as browsing the Web. In addition to the circuit switched network described above, GSM network 102 is communicatively coupled to data network 101 to provide a packet switched network for relaying data packets (e.g., wireless application protocols (WAP), SMS, MMS, EMS, e-mail, Web access). Accordingly, data network 101 may be any one of a global data network (e.g., the Internet), a regional data network, or a local area network. The data network 101 may use common high-level protocols, such as TCP/IP and may comprise multiple networks of differing protocols connected through appropriate gateways. Client devices 103A, 103B, and 103N can also access servers 104, 106 over data network 101 directly through respective network connections, represented as solid lines in FIG. 1. These network connections are wired or wireless and are implemented using any known protocol.

During a conventional e-Commerce transaction, users 103 submit requests (e.g., HTTP, HTTPS) to view web pages 106C from their devices 103A, 103B, 103N, select items for purchase from inventory database 106B, and submit payment information through payment gateway integration server 105. Each of these steps is typically effected through Web-based content via Web browsers. However, as mentioned above, where client devices 103A, 103B, 103N are portable/mobile devices, the lack of memory capacity and processing power to host a browser with all the features necessary for effective e-Commerce limits the transactions between users 103 and various merchants. As a result, e-Commerce vendors fail to take advantage of mobile purchasing decisions made away from the browser or stationary workstation. Potential customers are beyond the reach of merchants when users 103 are unwilling to cooperate with a difficult transactional process.

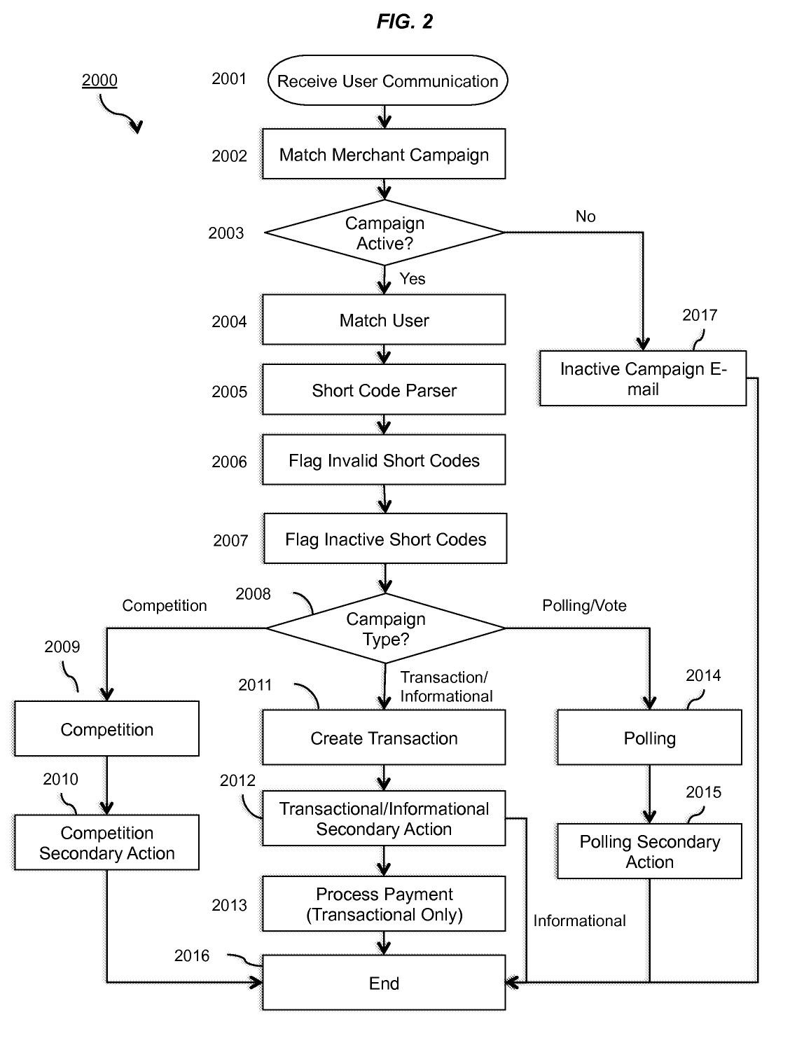

One approach to address this issue is shown in FIG. 2, which illustrates a process 2000 in accordance with a preferred embodiment of the present invention. Process 2000 may consist of various program modules including routines, programs, objects, components, data structures, and so on that perform particular tasks or implement particular abstract data types. In a distributed computing environment, these modules are located in both local and remote storage devices including memory storage devices.

Process 2000 is initiated when a user 103 sends a communication from user device 103A, 103B, or 103N to processing server 104 (starting block 2001). In one embodiment, this communication is text-based and includes, but is not limited to, e-mails, social media interactions (e.g., Facebook®, Twitter®, LinkedIn®, Pinterest® and MySpace® messages), and SMS messages. Users 103 browse items for sale—each item having an identifiable short-code—using not only electronic Web-based catalogues, but also conventional product advertisements. For example, users 103 may find a product of interest in print catalogues (e.g., newspapers, magazines, catalogues), television, radio, e-mail, and so on. Accordingly, the process 2000 provides the advantage of extending e-Commerce to alternative broadcast mediums and consequently enables the user 103 to make purchases/transactions that are unaffected by mobile Web tailoring methods.

Once a user 103 selects items for purchase, the user sends a text-based communication (e.g., e-mail, direct message, personal/private/public tweet, SMS) identifying the products' short-codes from one of devices 103A, 103B, 103N to processing server 104 over data network 101. The communication is addressed to the campaign address (e.g., e-mail address, Twitter® handle, Facebook® username, and so on) of the merchant who is offering the items selected for purchase. The source of the communication (e.g., a “from” address indicating user's 103 e-mail, user's 103 Twitter® handle, mobile number) is included in the message. Each of these communications can be generated using native mobile technologies (e.g., e-mail, SMS) without additional software.

For electronic catalogues, a hyperlink may be provided for one or more items that can be purchased. Accordingly, in one embodiment, selecting an item for purchase may comprise clicking the hyperlink to generate a pre-populated e-mail including the short-code for that product addressed to the vendor's campaign. In an alternative embodiment, clicking a hyperlink for a particular product redirects users 103 to a single Web-page for checkout, pre-populated with the short-code for the item(s) in the hyperlink and the merchant's campaign address. For example, a user 103 may select an item for purchase by clicking a Web-button (e.g., a “Buy Now” button) embedded on a Web-page or blog that identifies a particular product. Accordingly, Web-buttons provide the additional advantage of creating a transactional layer to a merchant's Web-page in a similar way that social media buttons (e.g., Facebook® “Like” button, Twitter® “tweet” button, and so on) add a social layer to the Web. As those of ordinary skill in the art would appreciate, these Web-buttons often rely on programming code such as a Form element being embedded on a Web-page to perform a function. In one example, when clicked, a Web-based modal window or pop-up screen asks for the user's 103 e-mail address. The user 103 can then enter additional identifying information (e.g., e-mail address) on the checkout page for submission to processing server 104. Therefore, a text-based communication identifying the products' short-codes from one of devices 103A, 103B, 103N to processing server 104 also includes Application Layer protocol requests (e.g., HTTP, HTTPS) identifying product short-codes, merchant's campaign address, source identifiers, and so on. One of ordinary skill in the art would also appreciate that hyperlinks are not only accessed via direct clicks, but also through indirect contact, such as, Quick Response (“QR”) Codes storing addresses and URLs.

Processing server 104 receives the communication from the user 103 in response to a particular short-code(s). In one embodiment, processing server 104 is configured to receive one or more concurrent user communications from users 103 and stores the communications in a queue for subsequent processing. Data stored in the queue includes, inter alia, a communication ID, timestamp, source address, campaign address, data source type (e.g., social media, e-mail), and the text of the communication. For each message in the queue, processing server 104 then attempts to identify the appropriate vendor/merchant selling the product (action block 2002).

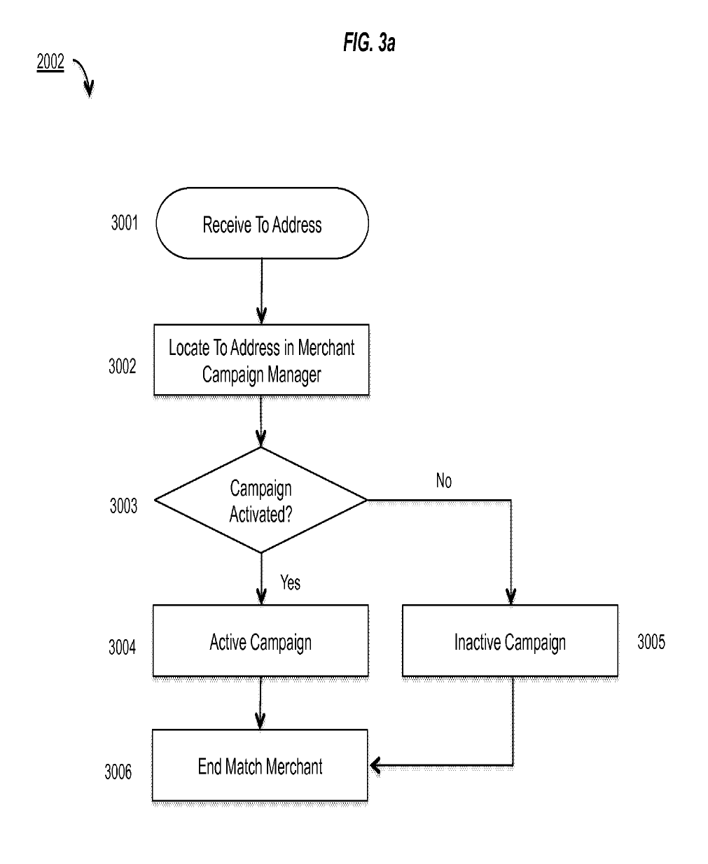

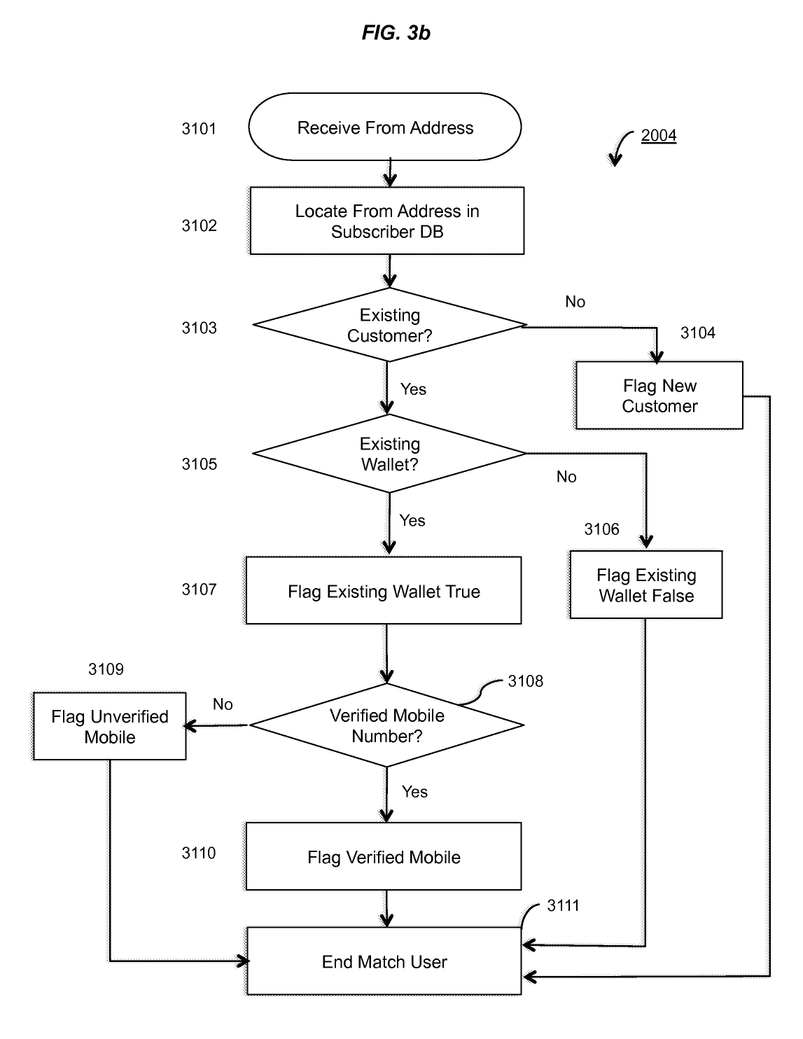

Turning to FIG. 3a, a more detailed flow diagram of matching a merchant's campaign address in action block 2002 is shown. Using the campaign address that the communication is addressed to (e.g., the “to” field of an e-mail, the handle of a vendor's Twitter® account, and so on) (starting block 3001), processing server 104 queries subscriber database 104B for a matching address of active merchant campaigns (action block 3002). If a matching campaign address has been located, the campaign may be either active or inactive (decision block 3003). Merchants and vendors can temporarily activate/de-activate their campaign address to receive and process user communications sent to that address. If the campaign address that the message is sent to is active (action block 3004), processing server 104 proceeds to process the remaining communication for that particular campaign (end block 3006). However, if a communication is addressed to a campaign that is not registered in subscriber database 104B (i.e., no matching campaign address found), invalid, or no longer active, processing server 104 flags the inactive campaign address to notify user 103 (action block 3005) and returns to action block 2003 (end block 3006).

Accordingly, returning to FIG. 2, inactive campaigns (decision block 2003) trigger a reply to user 103 that the campaign address their communication was addressed to is inactive (action block 2017) and the transaction could not be completed (end block 2016). In one embodiment, processing server 104 replies using the same medium the user 103 communication was received (e.g., reply-tweets (re-tweets), reply messages, reply to e-mails).

However, if a merchant address is determined to be active (decision block 2003), processing server 104 similarly determines whether the user 103 is an existing subscriber or new user (action block 2004). In one embodiment, the user 103 may have registered with processing server 104 via a mobile or stationary Web browser (e.g., through Web pages 104C). Registration includes submission of personal information (e.g., username, password, e-mail, mobile phone number, credit cards, billing, delivery, and so on) for storage in subscriber database 104B. Alternatively, users 103 also may begin a new order without an existing account, whereby a new account will be automatically created for the user 103.

Action block 2004 is further illustrated in FIG. 3b. Beginning with the source of the communication (e.g., the “from” address) (starting block 3101), processing server 104 queries subscriber database 104B for a matching address of existing subscribers (action block 3102). If the communication is sent from a user address that is not registered in subscriber database 104B (decision block 3103), processing server 104 flags the user address as a new customer (action block 3104) and returns to process 2000 (end block 3111). Otherwise, if a matching user address is located (decision block 3103), processing server 104 then determines whether the matched user has an existing “virtual wallet” stored in subscriber database 104B (decision block 3105).

A “virtual wallet” comprises the payment information mapped to a user account in subscriber database 104B. Database 104B is configured to maintain one or more payment methods for each user (e.g., multiple credit cards). “Virtual wallets” include such information as credit card numbers, expiration month, expiration years, billing address, delivery addresses, names, mobile numbers, and so on. Each time a new method for payment is added to a user's “virtual wallet,” processing server 104 may require user 103 to verify/validate the new method (e.g., temporary secure submission of a card verification number (“CVN”)). For accounts with multiple payment methods in their “virtual wallet,” users 103 can specify the order in which payment methods should be processed. For example, a user 103 may have information for a MasterCard, Visa, and American Express in their “virtual wallet.” The user 103 can set their preference for which credit card should be used first (e.g., Card 1—American Express; Card 2—Visa; Card 3—MasterCard). In the event a vendor/merchant accepts specific payment methods, processing server 104 will attempt to process a payment in accordance with the user's 103 preferred order. “Virtual wallets” may have been created from a previous transaction or through user input to processing server 104.

If an existing wallet is not mapped to the user found in subscriber database 104B, processing server 104 flags the user account, indicating no current payment methods exist (action block 3106), and returns to action block 2005 (end block 3111). Alternatively, user accounts associated with an existing wallet are flagged accordingly (action block 3107).

For these existing customers mapped to “virtual wallets,” processing server 104 subsequently checks within these “virtual wallets” for a verified mobile number (decision block 3108). This flag allows processing server 104 to determine an appropriate reply medium for user 103. In one embodiment, processing server 104 sends an SMS communication to the mobile number for user 103. Users 103 confirm receipt of the SMS communication (e.g., clicking a link or following SMS instructions) to verify their mobile number. Users 103 with verified mobile numbers are flagged in order to receive mobile-based replies, such as SMS communications (action block 3110). Users who have not provided a verified mobile number are similarly identified, such that processing server 104 will not communicate with user 103 through mobile-messaging services (action block 3109). Processing server 104 updates the user account in subscriber database 104B and returns to action block 2005 (end block 3111).

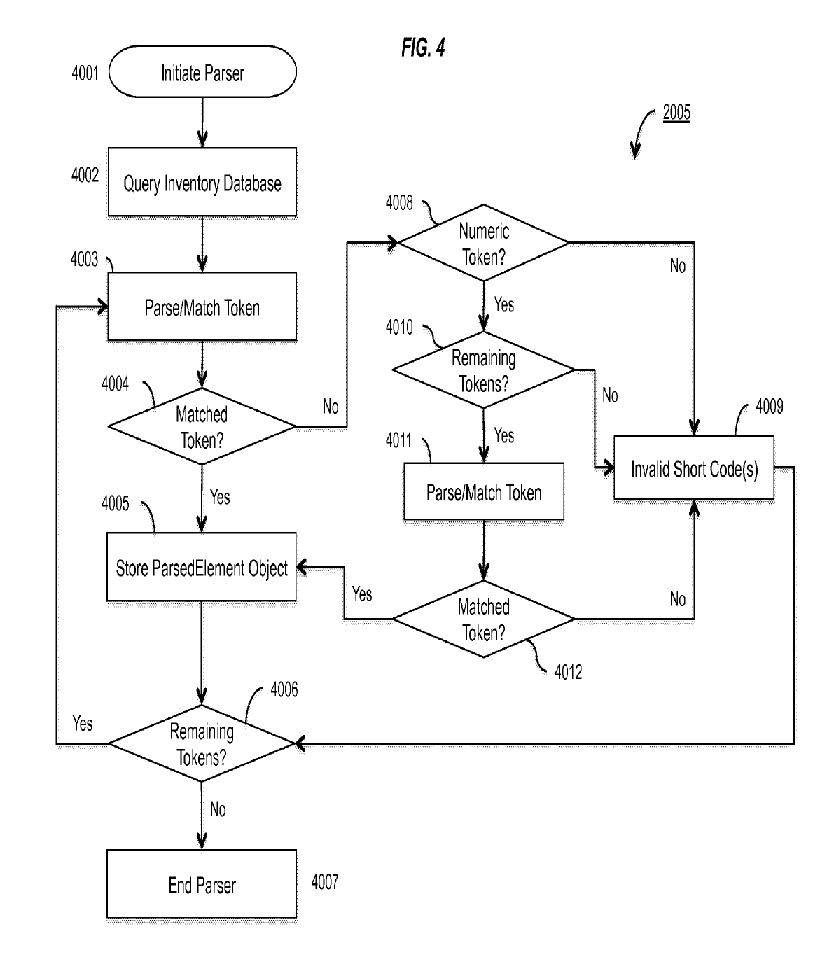

Returning to process 2000 in FIG. 2, after a user account is located in subscriber database 104B or flagged as a new customer, user 103 communications are further parsed for product short-codes (action block 2005). User 103 communications may contain one or more product short-codes comprising a single order. Multiple short-codes are often separated using field delimiters (e.g., spaces, underscores, commas, semicolons, carriage returns, and so on). Additionally, communications may contain not only short-codes but also a quantity. For example, the body of an e-mail including “2×[example short-code]” represents an order for 2 of an item represented as example short-code. Processing server 104 is also configured to process short-codes that are tightly grouped (e.g., ‘2×M445,’ ‘34ofSHOE,’ ‘10.5×K873’) or contain instructional text, which is ignored (e.g., between square brackets or following back-/forward-slashes). Parsing analyzes the text of the e-mail to create tokens for each short-code, such as by parsing for field/quantity delimiters. Processing server 104 iterates through each delimited text and numeral element to extract tokens, distinguishing each as a quantity or short-code, and flagging appropriately. Parsing and lexical analysis is generally well understood and appreciated to those of ordinary skill in the art. FIG. 4 illustrates one embodiment of parsing a user communication for short-codes in further detail.

Turning to FIG. 4, parsing is initiated upon the receipt of the user communication to process, such as from a queue, as discussed above (start block 4001). In one embodiment, elements are compared to an inventory of all valid short-codes available for the particular campaign the communication is addressed to—such as those stored in inventory database 106B. Accordingly, inventory database 106B is queried to retrieve a listing of all valid short-codes available from the merchant identified in process 2002 (action block 4002). These valid short-codes may be temporarily stored in memory (e.g., list, map, table), preferably as a sorted list. For each short-code token extracted from the user communication, the token is compared to the list obtained in action block 4002 (action block 4003). If the current short-code token matches an item in the list obtained in action block 4002 (decision block 4004), the current matched short-code token is stored as a single entry (i.e., a “ParsedElement”) in a separate data structure for future processing (e.g., list, map, table) (action block 4005). In a preferred embodiment, ParsedElements are stored as a linked list.

Alternatively, if the current short-code token cannot be matched to an element in the list obtained in action block 4002, processing server 104 determines whether the current short-code token may, instead, represent a quantity prefix to a valid short-code. This requires processing server 104 to use a “look-ahead” feature to determine whether any subsequent tokens are valid short-codes, indicating that the current unmatched numerical code may, in fact, represent a quantity instead of a product. Therefore, current non-numeric (decision block 4008), unmatched short-codes are flagged invalid (action block 4009) as they neither represent a quantity prefix to a subsequent short-code nor cannot be matched to existing inventory.

However, if the current unmatched short-code token is numeric (decision block 4008), processing server 104 determines if there are remaining tokens (decision block 4010) that may represent valid short-codes (action block 4011) (e.g., where the body of a communication contains “2×[example short-code],” the “2” is numeric and unmatched while “example short-code” matches a valid short-code). In other words, processing server 104 “looks-ahead” to match the next valid-short code, thereby indicating that the previous unmatched token is a quantity. If the next sequential element in the communication matches a valid short-code (decision block 4012), processor 104 assumes the current element represents quantity (e.g., “2”) and stores this element with the next sequential element (e.g., “example short-code”) as a single ParsedElement entry in the separate data structure (i.e., representing a multi-dimensional ordered pair of quantity and short-code). Otherwise, if the next sequential element in the communication does not match a valid short-code (decision block 4012), the current element cannot represent a valid short-code and is flagged invalid (action block 4009). Processing server 104 then continues to parse/match any remaining tokens in the communication (decision block 4006 and return to action block 4003) (end block 4007). If a quantity is not found for a particular element, processing server 104 assumes a single quantity. For e-mails that support conversation threading (i.e., grouping messages together in parent/child relationships based on topic, replies, and so on), processing server 104 parses only the most recent e-mail in a thread to avoid duplicate short-codes from previous orders.

With reference again to FIG. 2, using the ParsedElement list obtained from parsing short-codes in action block 2005, each short-code element in the communication that was not matched to a valid short-code is flagged as invalid (action block 2006). Invalid short-codes are those codes that processing server 104 could not identify as valid products/informational items maintained in inventory database 106B. Similarly, processing server 104 flags all inactive short-codes that were matched in action block 2005 (action block 2007). Although inactive short-codes were matched to valid products, these products are currently not available to user 103 (e.g., a merchant flags a seasonal item inactive during a specific time period).

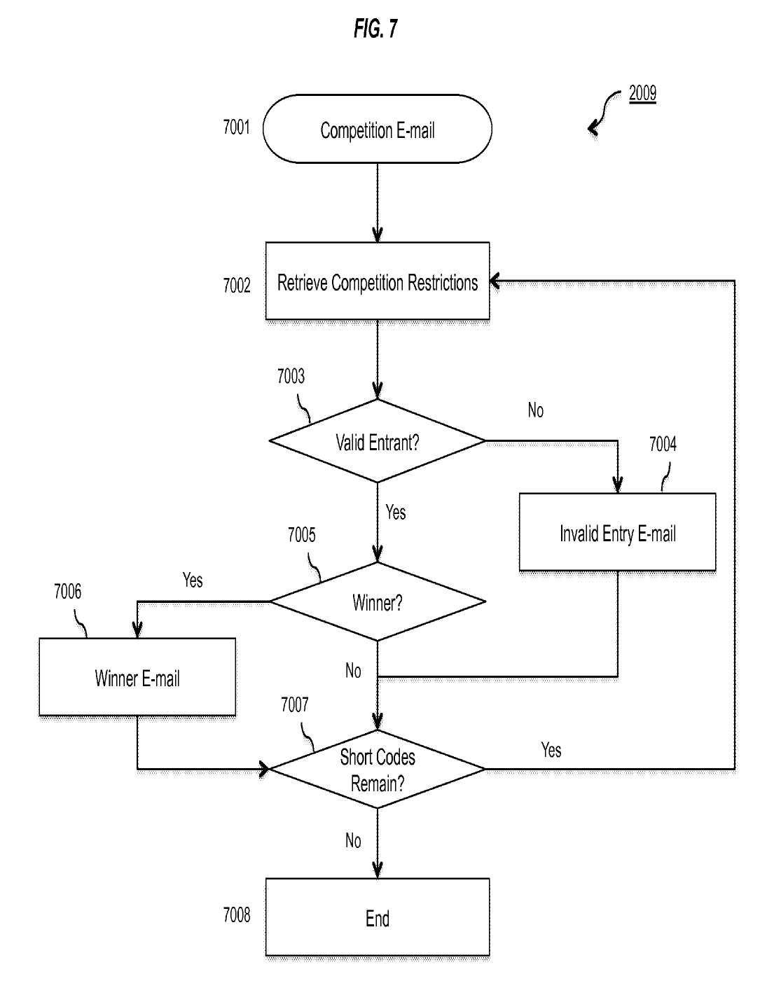

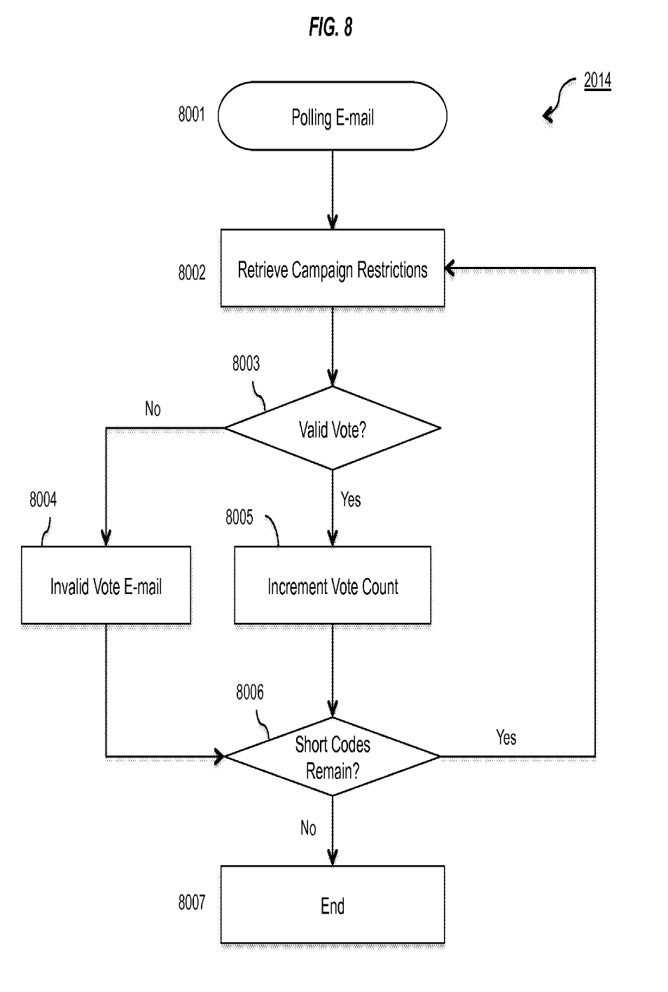

In order to determine how to further process valid, active short-codes, processing server 104 must determine the type of campaign the user communication is addressed to (decision block 2008). In a preferred embodiment, valid campaigns may support not only traditional consumer transactions (e.g., e-Commerce purchases and informational queries), but also competitions (e.g., electronic-based contests where users can win prizes) and voting environments (e.g., electronic elections and polls/polling). Competitions and voting environments will be further described with reference to FIG. 7 and FIG. 8, respectively.

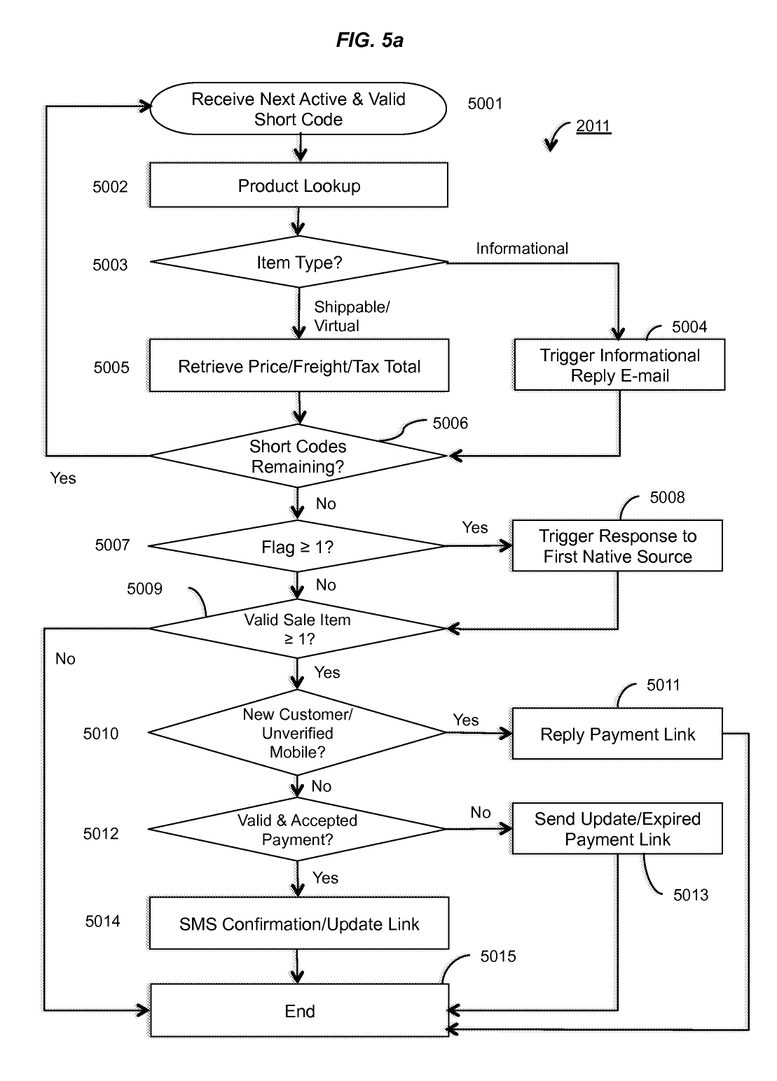

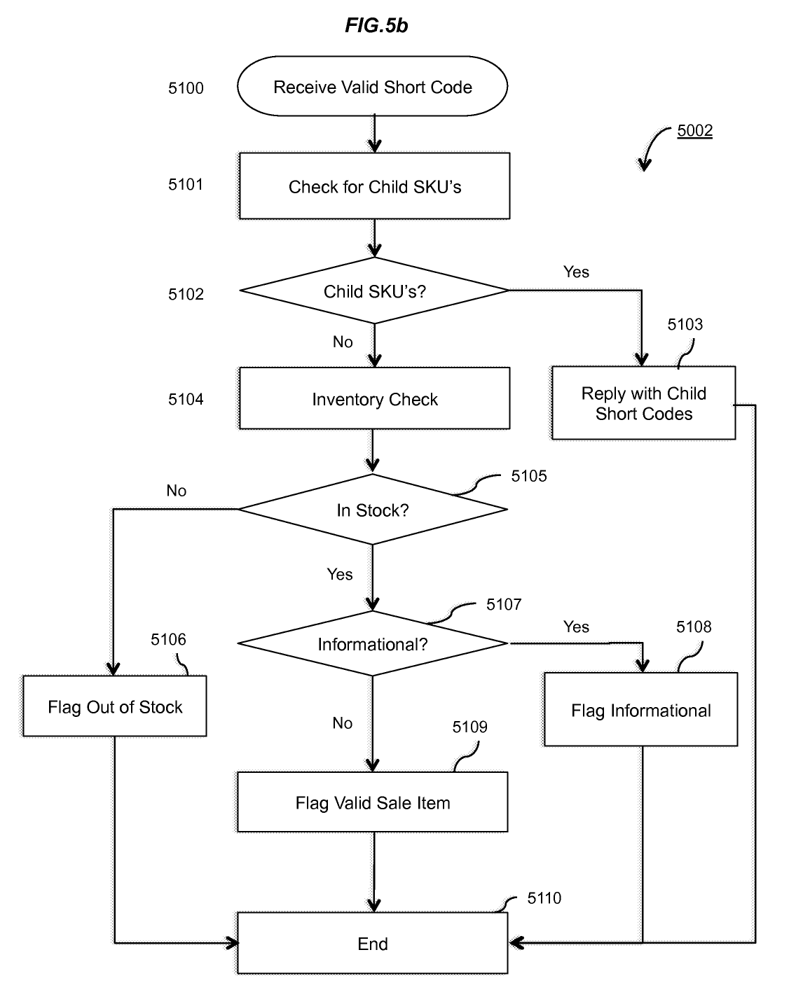

For campaigns configured to process traditional consumer transactions/informational transactions (decision block 2008), short-codes are processed to create a user order (action block 2011). Turning to FIG. 5a, creating a user order begins with the matched short-code list obtained in action block 2004 (start block 5001). Using the first matched short-code element in the matched list, product details are retrieved from inventory database 106B in order to generate an appropriate user response (action block 5002). It should be understood that an empty matched short-code list indicates all requested items are invalid. FIG. 5b illustrates this product lookup of action block 5002 in further detail. As discussed above, inventory is managed via parent/child short-code/SKU relationship. Processing server 104 receives the next valid short-code from the matched list (start block 5100) and queries database 106B to determine whether the short-code element is a parent of other child SKUs (action block 5101). For example, processing server 104 checks whether user 103 has placed an order for an item of clothing available in a number of colors. For products that are available in multiple configurations (i.e., parent SKUs) (decision block 5102), processing server 104 immediately replies to user 103 with a list of child SKUs for the particular product (action block 5103). This allows users 103 to distinguish between variations of products and choose a particular configuration. In one embodiment, processing server 104 sends an e-mail to the source address of the user 103 prompting user 103 to reply with the short-code of a specific child product (e.g., choosing a specific color for the clothing item requested). One skilled in the art would appreciate that for users ordering via social media platforms (e.g., tweets or Facebook® messages), processing server 104 replies in the manner the order was received (e.g., reply-tweets (re-tweets) or replies to messages). For example, for users 103 ordering via a tweet, processing sever 104 generates a reply tweet to the user's 103 Twitter® handle. In one embodiment, reply-tweets may include a hyperlink, which redirects users 103 to a single Web-page for checkout, as discussed above. This Web-page is pre-populated with the short-code for the item(s) in the link—or child short-codes to choose from—and the merchant's campaign address (i.e., Twitter® handle). Alternatively, reply-tweets may be informational and include a call-to-action for the user 103 to re-tweet a particular child short-code to complete the purchase (e.g., “RT to Buy!”).

If the product is only available in a single option (i.e., no child SKUs) (decision block 5102), processing server 104 proceeds to check the inventory of the item in database 106B (action block 5104). The inventory base that the merchant has available is matched against the quantity the user 103 is requesting of that particular item (decision block 5105). Processing server 104 flags out-of-stock short-codes where a merchant has an insufficient supply to meet the user's 103 demands (action block 5106). However, if there is sufficient supply of the item (decision block 5105), processing server 104 then determines whether the item represent either an informational or shippable/virtual good, as discussed above (decision block 5107). Informational items (action block 5108) and shippable/virtual good (action block 5109) are flagged accordingly. Flagging a shippable/virtual good indicates there is at least one valid sale item to be processed before proceeding with the next valid short-code (end block 5110). Informational goods will generate an immediate reply to a user 103 communication.

Returning to FIG. 5a, short-codes representing informational items flagged in action block 5108 (decision block 5003) generate an e-mail reply to user 103 (action block 5004). Because informational items do not require additional payment verification, the requested item is immediately delivered to the user 103. For example, a user 103 communication requesting a portable document file (“PDF”) menu from a restaurant merchant or an excerpt from a book generates an e-mail response containing the requested PDF, hyperlink to this item, or excerpt. Alternatively, short-codes representing shippable/virtual items flagged in action block 5109 (decision block 5003) are added to a single order and an updated price/freight/tax for the total items is calculated (action block 5005). Any remaining active and valid short-codes in the matched element list (decision block 5006) are similarly added to the order or used to generate informational replies (return to start block 5001).

Once all short-codes in the matched element list are processed (decision block 5006), processing server 104 determines if any flags for invalid short-codes, inactive short-codes, or out-of-stock short-codes exist (decision block 5007). Invalid short-codes were flagged in action block 2006 (see FIG. 2), inactive short-codes were flagged in action block 2007 (see FIG. 2), and out-of-stock items were flagged in action block 5106 (see FIG. 5b). These problematic short-codes are combined to create a single response, notifying user 103 of all short-codes that could not be processed (action block 5008). For example, processing server 104 replies with a single e-mail, or social media response as discussed above, indicating all requested items that are out of stock, items that are inactive, and short-codes that could not be mapped to a valid product.

After the user 103 is notified of any problematic short-codes, process 2011 returns to action block 2012 (end block 5015) unless an order was created with at least one valid item in action block 5002 (decision block 5009). If at least one valid item exists to create an order, process 2011 then determines the appropriate medium for providing user 103 with a unique confirmation link to process the order. This confirmation link will allow the user to submit payment information and confirm the order without having to manually create/log in to an account. New customers or users without a verified mobile number, as determined in process 2004, (decision block 5010) receive this confirmation link for the order via e-mail (action block 5011). As previously discussed, one skilled in the art would appreciate that for users ordering via social media platforms (e.g., tweets or Facebook® messages), processing server 104 replies with confirmation links in the manner the order was received (e.g., re-tweets or replies to messages). For example, reply-tweets include a hyperlink, which redirects users 103 to a single Web-page for checkout, as discussed above. This Web-page is pre-populated with the short-code for the item(s) in the link and the merchant's campaign address (i.e., Twitter® handle). After this initial transaction, payment information and address details are stored in subscriber database 104B to facilitate user's 103 future frictionless transactions with any subscribed merchant.

Alternatively, when returning customers with a verified mobile number create a new order, processing server 104 determines whether the customer has an existing valid and accepted payment method (decision block 5012). Although a “virtual wallet” is stored for returning customers, processing server 104 must consider whether existing payment methods of the “virtual wallet” are valid. As discussed above, a particular vendor may accept only specific payment methods. Therefore, processing server 104 will attempt to process the payment using any of user's 103 existing methods in their preferred order. If none of the methods in a user's existing wallet are accepted or all methods are expired, an SMS with an update link is provided to user 103 for specifying a new method of payment, thereby adding a valid and accepted credit card to their “virtual wallet” (action block 5013). Alternatively, if a valid payment method exists and is accepted, processing server 104 replies to user 103 with a confirmation link over SMS (action block 5014). User 103 confirms the order (i.e., clicks the link) to process the transaction using the current payment details in their “virtual wallet” (end block 5015). In an alternative embodiment, both a confirmation link and an update payment link are provided to user 103 if a valid form of payment exists (i.e., allowing the user 103 to specify an alternative payment method even if an existing method can be used). During this period, user 103 is not required to log in to an account and can confirm/process their order using a unique confirmation link.

With reference again to FIG. 2, after the order is created, process 2000 optionally processes the user 103 communication to provide secondary responses (action block 2012). In addition to the primary reply to the communication (i.e., creating a purchase order), a merchant may specify a secondary action for the data that user 103 has transmitted. Examples of transactional secondary actions include, but are not limited to, publishing/sharing/supporting purchases on one or more social media platforms (e.g., Facebook®, Twitter®, LinkedIn®, MySpace®), subscribing the user 103 to a database (e.g., e-mail newsletter), replying to an order, and so on. In another example, transactional secondary actions may include application programming interface (API)-based responses with external servers. For instance, an external server can be notified via a Web socket call upon events occurring or an external service can programmatically interact with the system to execute instructions that might otherwise be executed by a merchant.

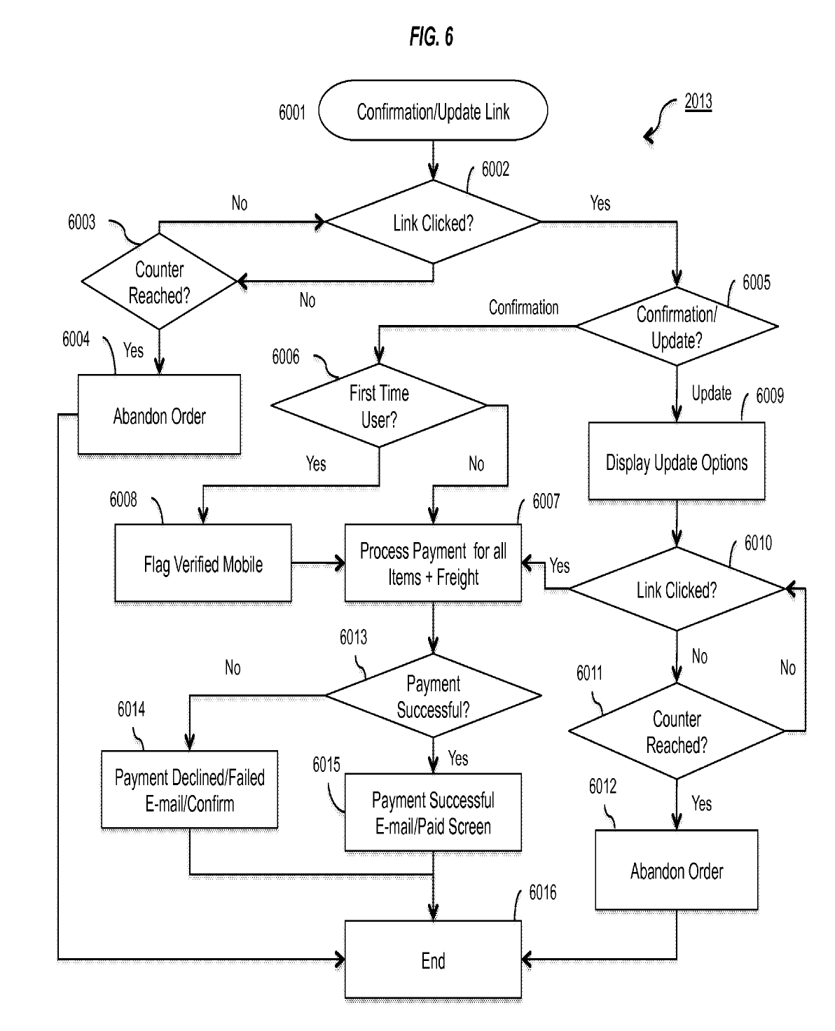

After optional secondary actions are performed, any existing orders are then processed for payment (action block 2013), which is further described with reference to FIG. 6. Processing payments depends on the confirmation/update links provided via SMS or e-mail in action block 2011 (starting block 6001). User 103 must click on any of these links to proceed with an order (decision block 6002). If the link has not been clicked for a programmable period of time (decision block 6003), the order will be abandoned (action block 6004). In one embodiment, links typically are active for 10 minutes where product inventory is reserved during this time for user 103. However, vendors and system administrators can customize the time period that a confirmation link will remain active prior to abandoning an order.

If user 103 confirms the order from their mobile device (decision block 6005), the mobile number associated with the device for first time users (decision block 6006) is verified and flagged for future communications with user 103 (action block 6008). Alternatively, if user 103 chose to update payment information via the update link (decision block 6005), processing server 104 presents user 103 with a Web-page to enter new payment details (action block 6009). Users 103 update payment details and are then presented with a process order option to complete the transaction (decision block 6010). As described, if this option has not been clicked for a programmable period of time (decision block 6011), the user's order will be abandoned and no purchase is processed (action block 6012).

Once the user 103 confirms the order (decision block 6005 and 6010), processing server 104 submits payment details through payment gateway integration server 105 for all items and freight (action block 6007). If the transaction is successfully processed (decision block 6013), the confirmation link points to a Web page displaying order details and confirming that the order has been processed (action block 6015). An e-mail, and/or an SMS, containing the same information is also sent to user 103. Unsuccessful orders similarly notify the user 103 that the order could not be processed with the specific reason (e.g., declined payment or declined delivery address) and an update payment link, as discussed above (action block 6014). Processing server 104 then returns to listen for the next user communication (end block 6016) (end block 2016, FIG. 2).

As discussed above, valid campaigns also may support both competitions (e.g., electronic-based contests where users can win prizes) and voting environments (e.g., electronic elections). Returning to FIG. 2, competitions (decision block 2008) are processed in action block 2009 and further illustrated in FIG. 7. A competition communication is a response to a merchant-sponsored contest (start block 7001). For example, a merchant may market a call to action such as “e-mail ‘win’ to contest@domain_name to enter” on a billboard, magazine, or television show. In another example, a merchant may advertise for users to “tweet the name of the first goal scorer to @competition name to enter” at a sporting event. In these examples, contest@domain_name and @competition name are competition campaigns and users' e-mail/tweet, respectively, the campaign address for a chance to win. Furthermore, to enter, the body of the e-mail, tweet, or text-based communication, must contain the short-code “win” or the name of the first goal scorer, in the previous examples, respectively.

Processing server 104 determines the campaign is a competition type and retrieves any competition restrictions (action block 7002). Specifically, a merchant may specify specific rules defining a valid entry. Examples of competition restriction include a single entry per user, geographical proximity, age groups, and so on. Processing server 104 replies to entries that fail to meet the merchant's requirements for valid participation (decision block 7003) with an e-mail notifying the user 103 (action block 7004). A valid entry is then given an opportunity to win the contest (decision block 7003). Winners are then determined based on merchant criteria (decision block 7005) and notified via e-mail (action block 7006). Examples of merchant criteria include the n^{th} e-mailer/tweeter or first person to respond with a specific short-code (e.g., the first goal scorer's name in the previous example above). Any remaining entries (e.g., e-mails with multiple short-codes) (decision block 7007) are similarly verified and entered into the competition (return to action block 7002). Process 2000 then optionally processes the user 103 communication to provide secondary responses to the competition communication (end block 7008).

Returning to FIG. 2, similar to secondary transactional actions, a merchant may specify a secondary action for the data that user 103 has transmitted (action block 2010) in addition to the primary reply to the communication (i.e., entering a contest). For example, although there may only be a single winner of a competition, each user who entered may be subscribed to a newsletter or sent a coupon voucher for the merchant's products. Processing server 104 then returns to listen for the next user communication (end block 2016).

In another embodiment of the present invention, process 2000 of FIG. 2 is similarly configured to support campaigns for voting environments (e.g., electronic elections). Polling campaigns (decision block 2008) are processed in action block 2014 and further illustrated in FIG. 8. A polling communication is a response to a merchant-sponsored request for a vote (start block 8001). For example, a merchant may market a call to action such as “vote for your favorite product: [short-code1], [short-code2], or [short-code3] to vote@domain_name” on a billboard, magazine, or television show. In this example, vote@domain_name is a polling campaign and users e-mail the campaign address with their favorite short-code selection.

Processing server 104 determines the campaign is a polling type and retrieves any voting restrictions (action block 8002). Specifically, a merchant may specify specific rules defining a valid entry (e.g., one vote per user, existing customers, and so on). Processing server 104 replies to entries that fail to meet the merchant's requirements for a valid election (decision block 8003) with an e-mail notifying the user 103 (action block 8004). A counter of valid votes for a specific selection is then incremented (action block 8005) until all votes in the communication are processed (decision block 8006) (return to action block 7002). Process 2000 then optionally processes the user 103 communication to provide secondary responses to the polling communication (end block 8007).

Returning to FIG. 2, after the vote is tallied, a merchant may specify a secondary action for the data that user 103 has transmitted (action block 2015) in addition to the primary reply to the communication (i.e., submitting a vote). Processing server 104 then returns to listen for the next user communication (end block 2016).

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions described herein is merely illustrative, and the invention may appropriately be performed using different or additional process actions, or a different combination or ordering of process actions. For example, this invention is particularly suited for e-Commerce systems, such as mobile-based consumer transaction environments; however, the invention can be used for any electronic communication using short-codes. Additionally and obviously, features may be added or subtracted as desired. Accordingly, the invention is not to be restricted except in light of the attached claims and their equivalents.

What is claimed is:

1. A system for facilitating frictionless transactions between a client device and server system using short-codes, comprising:
a subscriber database coupled to the server system;
an inventory database coupled to the server system defining an inventory of one or more products for distribution to the client device;
wherein the client device is configured to access a data network and a Global System for Mobile Communications (“GSM”) network; and
wherein the server system is accessible over the data network and further includes a computer program product having a computer-usable medium with a sequence of instructions which, when executed by a processor, causes said processor to execute a process that facilitates frictionless transactions between the client device and server system, said process comprising:
receiving a text-based communication sent from the client device over a first native communication medium, the text-based communication having a source address identifying a user of the client device, a recipient address, and one or more of said short-codes, wherein each short-code uniquely identifies an item available in said inventory database from said recipient address;
parsing the text-based communication for said one or more short-codes;
retrieving any additional data associated with said source address available from said subscriber database;
retrieving any additional data associated with said one or more short-codes available from said inventory database; and
replying to the client device using the source address over a second native communication medium based on the any additional data associated with the one or more short-codes and the additional data associated with said source address to complete a frictionless transaction.

2. The system of claim 1, wherein the first native communication medium uses native software applications of the client device and is selected from the group comprising: (1) electronic mail (“e-mail”); (2) social media platforms (e.g., Twitter®, Facebook®, and so on); and (3) short message service (“SMS”).

3. The system of claim 1, wherein the second native communication medium uses native software applications of the client device and is selected from the group comprising: (1) electronic mail (“e-mail”); (2) social media platforms (e.g., Twitter®, Facebook®, and so on); and (3) short message service (“SMS”).

4. The system of claim 1, further comprising a payment integration gateway server accessible over the data network configured to authorize and process electronic payment details between the client device and server system, and wherein retrieving additional data associated with said one or more short-codes further comprises:
retrieving any valid, available products associated with said one or more short-codes;
generating a purchase order for said one or more valid, available products available from said recipient address defined in said inventory database; and
wherein replying to the client device using the source address over a second native communication medium further comprises:
confirming the order through the second native communication medium using the any additional information stored in the subscriber database for said user; and
processing a payment for said order through the payment integration gateway server upon receipt of confirmation from the client device.

5. The system of claim 4, wherein subsequent to replying to the source address using said second native communication medium, the process further comprises subscribing the source address to a list stored in said subscriber database.

6. The system of claim 1, wherein retrieving additional data associated with said one or more short-codes available from said inventory database further comprises:
retrieving polling restrictions associated with said short-codes;
determining valid short-codes based on polling restrictions; and
wherein replying to the source address using said second native communication medium further comprises:
incrementing a vote count for one or more options in a poll, wherein each polling option is uniquely identifiable via the one or more valid short-codes; and
notifying the source address of the results of the vote over said second native communication medium.

7. The system of claim 1, wherein retrieving additional data associated with said one or more short-codes available from said inventory database further comprises:
retrieving competition restrictions associated with said short-codes;
determining valid short-codes based on competition restrictions; and
wherein replying to the source address using said second native communication medium further comprises:
entering a contest, wherein the one or more valid short-codes identify valid entries for said contest; and
notifying the source address if they are the winner of the contest using the second native communication medium.

8. The system of claim 1, wherein short-codes uniquely identify products available outside of electronic catalogues, including print catalogues, television, and radio.

9. The system of claim 1, wherein the text-based communication is generated using a hyperlink configured to create a text-based communication pre-populated with a source address identifying a user of the client device, a recipient address, and one or more of said short-codes.

10. The system of claim 1, wherein the user of said client device does not need to be a previous user or log in to an additional account.

11. A method of facilitating frictionless transactions initiated from a client device to a server system using short-codes, comprising:
receiving a text-based communication sent from the client device using a first native communication medium, the text-based communication having a source address identifying a user of the client device, a recipient address, and one or more short-codes, wherein each short-code uniquely identifies an item available defined in an inventory database from said recipient address;
parsing the text-based communication for said one or more short-codes;
retrieving any additional data associated with said source address available from a subscriber database;
retrieving any additional data associated with said one or more short-codes available from said subscriber database; and
replying to the client device using the source address over a second native communication medium based on the any additional data associated with the one or more short-codes and the any additional data associated with said source address to complete a frictionless transaction.

12. The method of claim 11, wherein the first native communication medium uses native software applications of the client device and is selected from the group comprising: (1) electronic mail (“e-mail”); (2) social media platforms (e.g., Twitter®, Facebook®, and so on); and (3) short message service (“SMS”).

13. The method of claim 11, wherein the second native communication medium uses native software applications of the client device and is selected from the group comprising: (1) electronic mail (“e-mail”); (2) social media platforms (e.g., Twitter®, Facebook®, and so on); and (3) short message service (“SMS”).

14. The method of claim 11, wherein retrieving additional data associated with said one or more short-codes further comprises:
retrieving any valid, available products associated with said one or more short-codes;
generating a purchase order for said one or more valid, available products available from said recipient address defined in the said inventory database; and
wherein replying to the client device using the source address over a second native communication medium further comprises confirming the order through the second native communication medium using any additional information stored in the subscriber database for said user.

15. The method of claim 14, wherein subsequent to replying to the source address using said second native communication medium, the process further comprises subscribing the source address to a list stored in said subscriber database.

16. The method of claim 11, wherein retrieving additional data associated with said one or more short-codes available from said inventory database further comprises:
retrieving polling restrictions associated with said short-codes;
determining valid short-codes based on polling restrictions; and
wherein replying to the source address using said second native communication medium further comprises:
incrementing a vote count for one or more options in a poll, wherein each polling option is uniquely identifiable via the one or more valid short-codes; and
notifying the source address of the results of the vote over said second native communication medium.

17. The method of claim 11, wherein retrieving additional data associated with said one or more short-codes available from said inventory database further comprises:
retrieving competition restrictions associated with said short-codes;
determining valid short-codes based on competition restrictions; and
wherein replying to the source address using said second native communication medium further comprises:
entering a contest, wherein the one or more valid short-codes identify valid entries for said contest; and
notifying the source address if they are the winner of the contest using the second native communication medium.

18. The method of claim 11, wherein short-codes uniquely identify products available outside of electronic catalogues, including print catalogues, television, and radio.

19. The method of claim 11, wherein the text-based communication is generated using a hyperlink configured to create a text-based communication pre-populated with a source address identifying a user of the client device, a recipient address, and one or more of said short-codes.

20. The method of claim 11, wherein the user of said client device does not need to be a previous user or log in to an additional account.
